(19) United States
(12) Patent Application Publication
(10) Pub. No.: US 2024/0121703 A1
(43) Pub. Date: Apr. 11, 2024

(54) METHOD AND COMMUNICATION SYSTEM FOR ARTIFICIAL INTELLIGENCE SETTING

(71) Applicant: Rohde & Schwarz GmbH & Co. KG, Muenchen (DE)

(72) Inventors: Lilei WANG, Muenchen (DE); Juergen SCHLIENZ, Muenchen (DE)

(73) Assignee: Rohde & Schwarz GmbH & Co. KG, Muenchen (DE)

(21) Appl. No.: 18/483,868

(22) Filed: Oct. 10, 2023

(30) Foreign Application Priority Data
Oct. 10, 2022 (CN) 2022112360680

(51) Int. Cl. H04W 48/10; H04W 8/22

(52) U.S. Cl. CPC H04W 48/10; H04W 8/22

(57) ABSTRACT

The present disclosure relates to a method of artificial intelligence (AI) setting within a communication system with a base station and several user equipments (UEs). The user equipments each report an artificial intelligence parameter for universal communications identifier (UCI) capabilities to the base station. The user equipments are grouped by the base station based on the artificial intelligence parameter for the universal communications identifier capabilities. The base station multicasts artificial intelligence configuration to each group of user equipments separately. Further, a communication system is described.

### FIELD OF THE DISCLOSURE

Embodiments of the present disclosure relate to a method of artificial intelligence (AI) setting within a communication system with a base station and several user equipments (UEs). Further, embodiments of the present disclosure relate to a communication system for artificial intelligence setting.

### BACKGROUND

In the state of the art, artificial intelligence, for example machine learning, for channel state information (CSI) feedback enhancement is an important use case currently discussed in 3GPP RANI. However, it is not clear how the participants of the communication system, namely the base station and several user equipments, agree on artificial intelligence models to be used, for instance auto-encoder/auto-decoder information for CSI feedback compression.

It is assumed so far that negotiation of artificial intelligence models is specific for the user equipments and, therefore, a large overhead in UMTS Air Interface, also called Uu interface, is needed, which is also called air interface.

However, the large overhead reduces the efficiency of the communication system, as it causes to high network loads within the communication system.

Accordingly, there is a need for negotiating artificial intelligence models in a more efficient manner while maintaining the flexibility.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure provides a method of artificial intelligence (AI) setting within a communication system with a base station and several user equipments (UEs). In an embodiment, the user equipments each report an artificial intelligence parameter for universal communications identifier (UCI) capabilities to the base station. The user equipments are grouped by the base station based on the artificial intelligence parameter for the universal communications identifier capabilities. The base station multicasts artificial intelligence configuration to each group of user equipments separately.

The main idea is to improve the efficiency by reducing the network loads while multicasting the artificial intelligence configuration in a group-wise manner, e.g. transmitting the artificial intelligence configuration to more than one user equipment simultaneously. Accordingly, it is not necessary to negotiate of artificial intelligence models in a UE-specific manner. In other words, multicasting is the gist of the embodiments of the present disclosure, which reduces the network load of the communication system.

For instance, a first group of UEs, for instance two UEs, might support a first capability, whereas a second group of UEs, for instance four UEs, might support a seventh capability, wherein the respective capabilities are associated with dedicated artificial intelligence parameters. Therefore, the UEs are grouped in the respective groups, namely the two UEs associated with the first capability in the first group and the four UEs associated with the seventh capability in the second group.

Generally, a two-sided AI can be established by the communication system, as the UE(s) and the base station both use the same AI parameters, which is ensured by analyzing the AI parameters reported by the UE(s) and the AI configuration multicast subsequently.

An aspect provides that the base station, for example, multicasts the respective artificial intelligence configuration in dependency of the artificial intelligence parameter for the universal communications identifier capabilities. Hence, the UEs are grouped based on the artificial intelligence parameter for the universal communications identifier capabilities. The respective artificial intelligence configuration is forwarded to the UEs of the respective groups by means of multicasting.

Another aspect provides that the user equipments, for example, each receive the artificial intelligence configuration to be used. All UEs receive their artificial intelligence configuration to be used, wherein the UEs receive their respective artificial intelligence configuration to be used in a grouped manner. This means that all UEs of a certain group receive their respective artificial intelligence configuration (substantially) simultaneously, as the base station multicasts the respective artificial intelligence configuration to all UEs of the respective group (simultaneously).

A further aspect provides that the artificial intelligence configuration, for example, is submitted via at least one specific multicast message. Particularly, the at least one specific multicast message is scrambled by multicast radio network temporary identifier (RNTI). Hence, the artificial intelligence configuration(s) to be forwarded from the base station to the UEs is performed by a multicast signaling scrambled by multicast RNTI. The multicast message may be scrambled by Multicast-for-AI-RNTI.

In some embodiments, the at least one specific multicast message may encompass information concerning the user equipments of the respective group which are addressed by the respective specific multicast message. This ensures that the respective UEs of a certain group for which the multicast message is intended can verify that the multicast message received is an intended one. Put differently, UEs not mentioned in the multicast message will ignore the respective content of the multicast message.

Alternatively, an artificial intelligence configuration may be added to a message to be transmitted, particularly by means of radio resource control signaling. For instance, UE specific AI information is transmitted in UE-specific RRC signaling.

Accordingly, either an AI specific multicast message or an AI specific together with a UE specific signaling is used to forward the artificial intelligence configuration to the UEs.

Another aspect provides that the universal communications identifier capabilities, for example, comprise artificial intelligence capability of channel state information (CSI) feedback and/or hybrid automatic repeat request (HARQ). Accordingly, the UEs may be grouped with respect to their artificial intelligence capability of channel state information (CSI) feedback. The hybrid automatic repeat request (HARQ) is a combination of high-rate forward error correction (FEC) and automatic repeat request (ARQ) error-control. Hence, the UEs may be grouped with respect to their artificial intelligence capability of HARQ.

In some embodiments, at least one of a radio network temporary identifier (RNTI) list or a user equipment identification list may be provided, which indicates which user equipments apply for artificial intelligence based compression. Based on this information, the grouping may take place, as only those UEs are grouped in a certain group that apply for artificial intelligence based compression.

According to a further aspect, the artificial intelligence parameter and/or the artificial intelligence configuration, for example, is an artificial intelligence model type, a number of layers, a number of neurons of each layer, a trained weight values, an artificial intelligence model maturity and/or a duration of artificial intelligence model application. Hence, a single of the above-mentioned parameters or any combination of the above-mentioned parameters may be transmitted from the UEs to the base station. In a similar manner, the artificial intelligence configuration multicast may also comprise a single of the above-mentioned parameters or any combination of the above-mentioned parameters.

In some embodiments, information about which channel uses which artificial intelligence model type may be taken into account by the base station. In some embodiments, the artificial intelligence configuration is chosen by the base station based on priorities, sizes and/or latency requirements of the respective channels. Hence, information is obtained which channel uses which AI model, e.g. for compression. The information may be configured by the AI specific multicast message, for example PDSCH using a first AI model, PDCCH using a second AI model, PUSCH using a third AI model and/or PUCCH using a fourth AI model. The respective AI models may relate to Convolutional Neural Network (CNN), a Recurrent Neural Network (RNN), a Deep Neural Network (DNN) and so on. Hence, the respective type of AI model is chosen based on priority of channel, amount of channel size and latency requirement.

In some embodiments, the base station may request the user equipments to report the artificial intelligence parameter for the universal communications identifier capabilities. Hence the UEs are prompted by the base station to report the artificial intelligence parameter for the universal communications identifier capabilities.

In some embodiments, the base station may be a gNodeB base station, also called gNB, which is a 5G-NR base station.

In some embodiments, an auto-encoder used in the respective user equipment may be configured based on the artificial intelligence configuration. The encoding functionality of the UE can be based on AI.

In some embodiments, an auto-decoder used in the base station is also configured based on the artificial intelligence configuration. The decoding functionality of the base station can be based on AI.

Generally, a two-sided AI can be established accordingly.

Furthermore, embodiments of the present disclosure provide a communication system for artificial intelligence (AI) setting. In an embodiment, the communication system comprises a base station and several user equipments. The communication system is configured to perform the method described above. The respective characteristics and advantages mentioned above apply to the communication system in a similar manner.

In general, the concept of a Universal Communications Identifier (UCI) was introduced by ETSI to provide a flexible means of identification in an increasingly communications intensive world. To achieve its full potential the UCI needs to operate within an architecture capable of supporting the concept of personal control of communication. When the UCI is used it:
can identify the user in a meaningful way;
minimizes the need to for a user to have many different identifiers for a range of different communications services;
provides the potential for verifying the true identity of the originator or recipient of a communication;
is unchanged when moving to a different service provider or service type; and
may provide a common environment for the management and control of all personal communications irrespective of service type (as opposed to a range of different control mechanisms that are service specific).

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a communication system according to an embodiment of the present disclosure in a first state;

FIG. 2 shows a communication system according to an embodiment of the present disclosure in a second state;

FIG. 3 shows an overview illustrating a method of artificial intelligence (AI) setting according to embodiment of the present disclosure;

FIG. 4 an overview illustrating different channel allocations;

FIG. 5 a first exemplary multicast message used by a variant of the method according to embodiment of the present disclosure;

FIG. 6 a second exemplary multicast message used by a variant of the method according to embodiment of the present disclosure; and

FIG. 7 a table illustrating information to be included into an existing message.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps. As such, one of ordinary skill will appreciate that such examples are within the scope of the claimed embodiments.

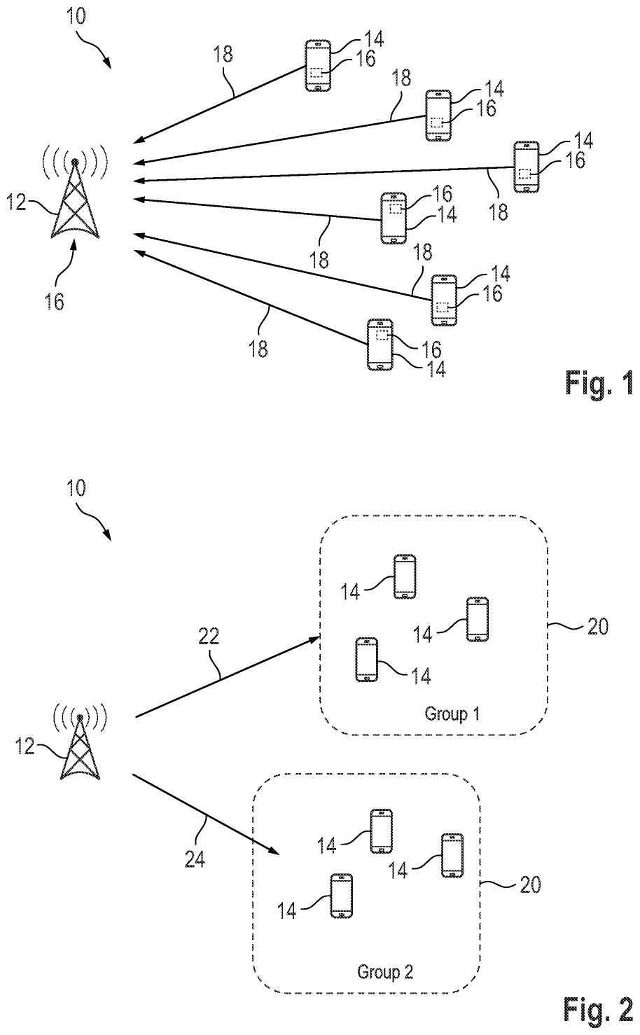

In FIGS. 1 and 2, a communication system 10 is shown that comprises a base station 12 and several user equipments 14. The base station 12 is a gNodeB base station that communicates with the user equipments 14, namely mobile phones located in a respective cell of the base station 12.

The base station 12 as well as each of the user equipments 14 comprise a processing circuit 16 which is generally configured to perform algorithms for artificial intelligence. Hence, a two-sided artificial intelligence model may be used in the communication between the base station 12 and the respective user equipments 14.

The communication system 10 is generally configured to perform a method of artificial intelligence (AI) setting as will be described hereinafter.

In a first step shown in FIG. 1, the user equipments 14 each report an artificial intelligence parameter for universal communications identifier (UCI) capabilities to the base station 12 via respective reporting messages 18.

In a second step, the base station 12 analyzes the reporting messages 18 received, namely the artificial intelligence parameters for universal communications identifier (UCI) capabilities which were received by the reporting messages 18.

In a third step, the base station 12 groups the several user equipments 14 based on the artificial intelligence parameter for the universal communications identifier capabilities received. Accordingly, different groups 20 of user equipments 14 are obtained which can be addressed individually and independently of each other. In FIG. 2, a first group 20 of three user equipments 14 and a second group 20 of three user equipments 14 are obtained based on the artificial intelligence parameter for the universal communications identifier capabilities received from these user equipments 14.

In a fourth step shown in FIG. 2, the base station 12 multicasts artificial intelligence configuration to each group 20 of user equipments 14 separately, for example subsequently. The artificial intelligence configuration is received by the respective user equipments 14 which process the artificial intelligence configuration received to configure themselves, thereby enabling the user equipments 14 to implement the two-sided artificial intelligence model.

In some embodiments, the base station 12 transmits a first multicast message 22 to one group 20, for instance the first group, and (subsequently) a second multicast message 24 to one group 20, for instance the second group.

Since the respective multicast messages 22, 24 are transmitted, the user equipments 14 of the respective groups 20 receive the respective multicast messages 22, 24 (substantially) simultaneously.

The base station 12 multicasts the respective artificial intelligence configuration in dependency of the artificial intelligence parameter for the universal communications identifier capabilities, which was received previously as shown in FIG. 1.

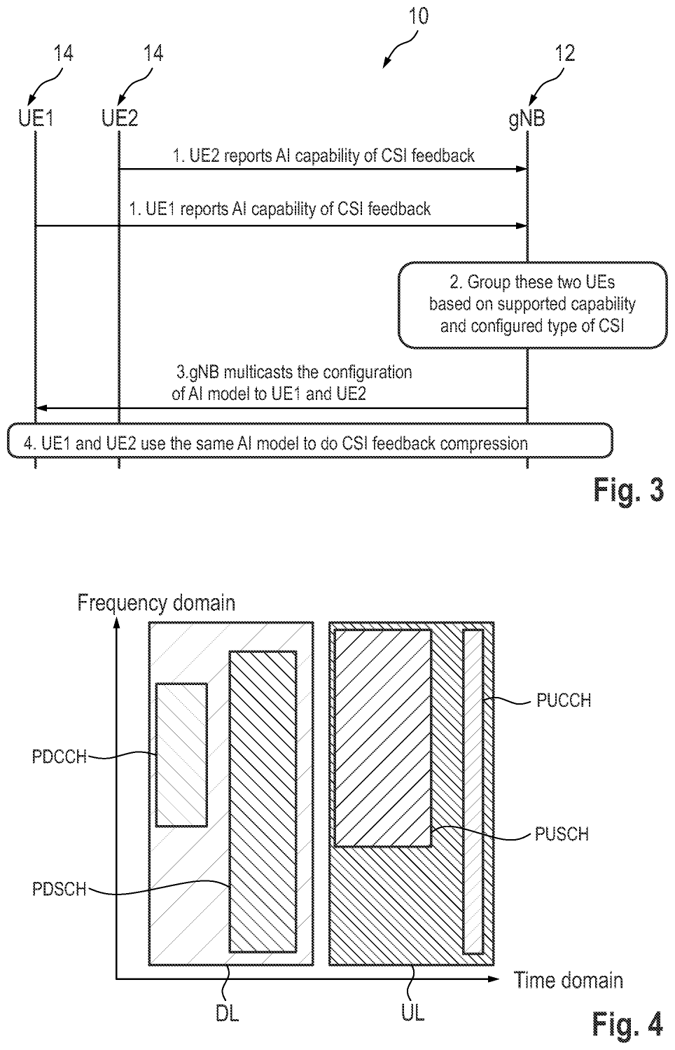

FIG. 3 further shows a certain example according to which the universal communications identifier capabilities relate to a channel state information (CSI) feedback. Hence, the user equipments 14 report the AI capability of CSI feedback to the base station 12.

The base station 12 groups the user equipments 14 based on supported capability and configured type of CSI. Afterwards, the base station 12 multicasts the artificial intelligence configuration to groups 20 obtained.

In the example shown, both user equipments 14 use the same AI model to do CSI feedback compression. Hence, both user equipments 14 are grouped to the same group 20.

Since the CSI feedback compression is associated with the two-sided AI, an auto-encoder used in the respective user equipment 14 is configured based on the artificial intelligence configuration multicast previously by the base station 12. Further, an auto-decoder used in the base station 12 is also configured based on the artificial intelligence configuration. This ensures that the two-sided AI can be established between the base station 12 and the respective user equipment 14, for example the auto-decoder and the auto-encoder.

The base station 12 may also take at least one of a radio network temporary identifier (RNTI) list or a user equipment identification list into account, which indicates which user equipments 14 apply for artificial intelligence based compression. The respective user equipments 14 can be grouped accordingly based on this information.

Alternatively or additionally to the CSI feedback, the universal communications identifier capabilities may comprise artificial intelligence capability of hybrid automatic repeat request (HARQ).

As shown in FIG. 4, information about which channel uses which artificial intelligence model type is taken into account by the base station 12 and/or transmitted by the base station 12, namely included in the multicast message.

Accordingly, the artificial intelligence configuration can be chosen by the base station 12 based on priorities, sizes and/or latency requirements of the respective channels. In the example shown in FIG. 4, the channels PDCCH, PDSCH, PUSCH and PUCCH are shown. These channels have different priorities, sizes and/or latency requirements.

For instance, PDSCH uses a first AI model, uses using a second AI model, PUSCH uses a third AI model and/or PUCCH uses a fourth AI model. The respective AI models may relate to Convolutional Neural Network (CNN), a Recurrent Neural Network (RNN), Deep Neural Network (DNN) and so on.

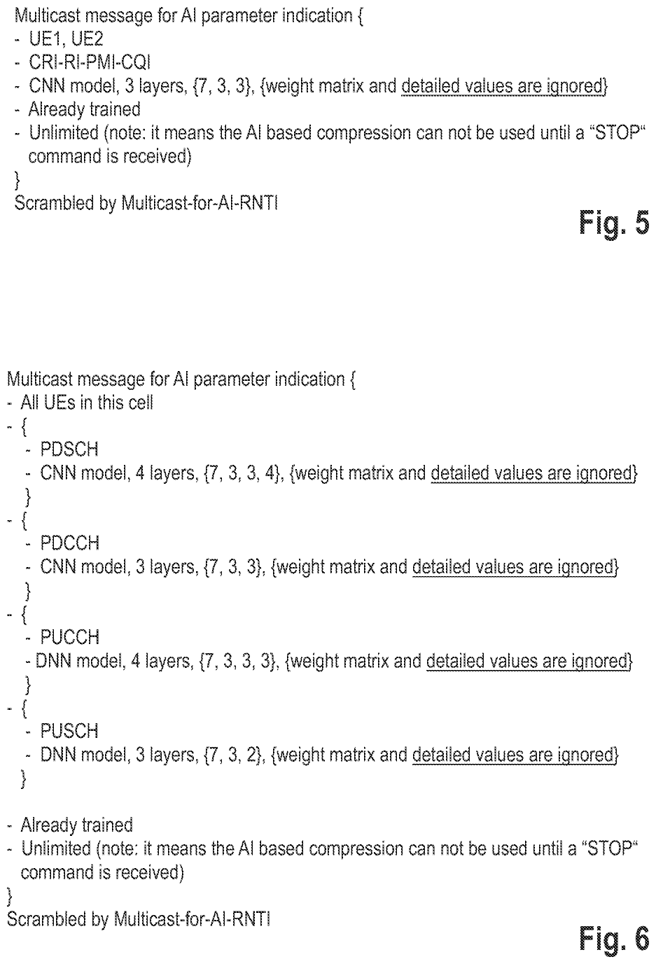

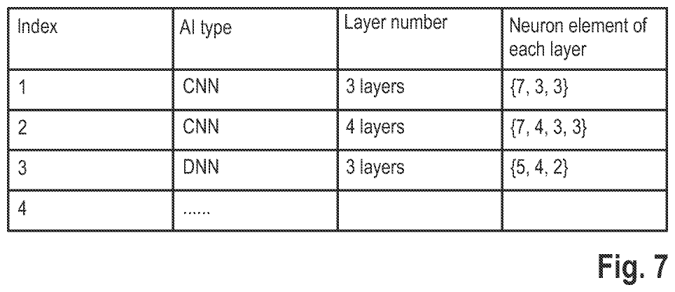

Generally, the artificial intelligence parameter reported by the UEs 14 and/or the artificial intelligence configuration multicast by the base station 12 may comprise an artificial intelligence model type, a number of layers, a number of neurons of each layer, a trained weight values, an artificial intelligence model maturity and/or a duration of artificial intelligence model application. This is also shown in FIGS. 5 and 7 to which reference is made. In FIGS. 5 to 7, different examples are shown how the base station 12 multicasts the artificial intelligence configuration to the user equipments 14 in a group-wise manner.

For instance, the artificial intelligence configuration is submitted via at least one specific multicast message, wherein the at least one specific multicast message is scrambled by multicast radio network temporary identifier.

In FIG. 5, it is shown that the at least one specific multicast message encompasses information concerning the user equipments 14 of the respective group 20 which are addressed by the specific multicast message, namely UE1 and UE2.

Moreover, the artificial intelligence model type, namely CNN, the number of layers, namely 3 layers, as well as the number of neurons of these layers are included, namely {7, 3, 3}. In addition, trained weight values may be included.

Further, the artificial intelligence model maturity, namely “already trained”, as well as the duration of artificial intelligence model application, namely “unlimited”, are included in the multicast message.

Moreover, it is shown in FIG. 5 that the multicast message is scrambled by RNTI, e.g. Multicast-for-AI-RNTI.

In FIG. 6, another example of a multicast message is shown, wherein information concerning the channels is included, namely AI configurations for different channels, for example PDSCH, PDCCH, PUCCH and PUSCH.

Specifically, a CNN model with 4 layers and {7, 3, 3, 4} neurons in these layers are associated with PDSCH. A CNN model with 3 layers and {7, 3, 3} neurons in these layers are associated with PDCCH. A DNN model with 4 layers and {7, 3, 3, 3} neurons in these layers are associated with PUCCH. A DNN model with 3 layers and {7, 3, 2} neurons in these layers are associated with PUSCH.

Furthermore, the artificial intelligence model maturity, namely “already trained”, as well as the duration of artificial intelligence model application, namely “unlimited”, are included in the multicast message.

In FIG. 7, an alternative is shown according to which the artificial intelligence configuration is added to a message to be transmitted, for example by means of radio resource control signaling. The information is provided in a table format as illustrated in FIG. 7.

Generally, the grouping of the UEs 14 into groups and multicasting the AI configurations to the respective groups reduce the network load of the communication system 10.

Certain embodiments disclosed herein include systems, apparatus, modules, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality described herein.

Of course, in some embodiments, two or more of these components, or parts thereof, can be integrated or share hardware and/or software, circuitry, etc. In some embodiments, these components, or parts thereof, may be grouped in a single location or distributed over a wide area. In circumstances where the components are distributed, the components are accessible to each other via communication links.

In some embodiments, one or more of the components, such as the base station 12 and the user equipments 14, referenced above include circuitry programmed to carry out one or more steps of any of the methods disclosed herein. In some embodiments, one or more computer-readable media associated with or accessible by such circuitry contains computer readable instructions embodied thereon that, when executed by such circuitry, cause the component or circuitry to perform one or more steps of any of the methods disclosed herein.

In some embodiments, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In some embodiments, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In some embodiments, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) (such as the base station 12, the user equipments 14, etc.) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein. All such combinations or sub-combinations of features are within the scope of the present disclosure.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method of artificial intelligence (AI) setting within a communication system with a base station and several user equipments (UEs), wherein the user equipments each report an artificial intelligence parameter for universal communications identifier (UCI) capabilities to the base station, wherein the user equipments are grouped by the base station based on the artificial intelligence parameter for the universal communications identifier capabilities, and wherein the base station multicasts artificial intelligence configuration to each group of user equipments separately.

2. The method according to claim 1, wherein the base station multicasts the respective artificial intelligence configuration in dependency of the artificial intelligence parameter for the universal communications identifier capabilities.

3. The method according to claim 1, wherein the user equipments each receive the artificial intelligence configuration to be used.

4. The method according to claim 1, wherein the artificial intelligence configuration is submitted via at least one specific multicast message.

5. The method according to claim 4, wherein the at least one specific multicast message is scrambled by multicast radio network temporary identifier.

6. The method according to claim 4, wherein the at least one specific multicast message encompasses information concerning the user equipments of the respective group which are addressed by the respective specific multicast message.

7. The method according to claim 1, wherein artificial intelligence configuration is added to a message to be transmitted.

8. The method according to claim 7, wherein the artificial intelligence configuration is added to the message to be transmitted by means of radio resource control signaling.

9. The method according to claim 1, wherein the universal communications identifier capabilities comprise artificial intelligence capability of channel state information (CSI) feedback and/or hybrid automatic repeat request (HARQ).

10. The method according to claim 1, wherein at least one of a radio network temporary identifier (RNTI) list or a user equipment identification list is provided, which indicates which user equipments apply for artificial intelligence based compression.

11. The method according to claim 1, wherein the artificial intelligence parameter and/or the artificial intelligence configuration is an artificial intelligence model type, a number of layers, a number of neurons of each layer, a trained weight values, an artificial intelligence model maturity and/or a duration of artificial intelligence model application.

12. The method according to claim 1, wherein information about which channel uses which artificial intelligence model type is taken into account by the base station.

13. The method according to claim 12, wherein the artificial intelligence configuration is chosen by the base station based on priorities, sizes and/or latency requirements of the respective channels.

14. The method according to claim 1, wherein the base station requests the user equipments to report the artificial intelligence parameter for the universal communications identifier capabilities.

15. The method according to claim 1, wherein the base station is a gNodeB base station.

16. The method according to claim 1, wherein an auto-encoder used in the respective user equipment is configured based on the artificial intelligence configuration.

17. The method according to claim 1, wherein an auto-decoder used in the base station is also configured based on the artificial intelligence configuration.

18. A communication system for artificial intelligence (AI) setting, wherein the communication system comprises a base station and several user equipments, and wherein the communication system is configured to perform the method according to claim 1.
